(19) United States
(12) Patent Application Publication
(10) Pub. No.: US 2014/0168119 A1
(43) Pub. Date: Jun. 19, 2014

(54) ELECTRONIC DEVICE AND CONTROL METHOD THEREOF

(71) Applicant: RISO KAGAKU CORPORATION, Tokyo (JP)

(72) Inventor: Yasuhiro ESAKI, Ibaraki (JP)

(73) Assignee: RISO KAGAKU CORPORATION, Tokyo (JP)

(21) Appl. No.: 14/098,802

(22) Filed: Dec. 6, 2013

(30) Foreign Application Priority Data
Dec. 19, 2012 (JP) 2012-276458

(51) Int. Cl. G06F 3/041

(52) U.S. Cl. CPC G06F 3/0412
USPC 345/173

(57) ABSTRACT

A printing machine includes: a display that displays an input screen; a touch panel that is arranged on the display and detects contact operation by an operator; and a controller that displays an operation region in the input screen, and controls operation processing for the input screen based on the contact operation to the touch panel with respect to the operation region.

### BACKGROUND OF THE INVENTION

1. Field of the Invention

The present invention relates to an electronic device provided with a touch panel.

2. Related Background of the Invention

Conventionally, an electronic device provided with a touch panel has been known. In such an electronic device, an operator can perform input operation to a screen by touching a position of a target object in the screen with a finger or the like (for example, refer to Patent Document 1).

### PRIOR ART DOCUMENT

### Patent Document

[Patent Document 1] U.S. Pat. No. 7,479,949

### SUMMARY OF THE INVENTION

Since in the operation to the touch panel, a hand is moved to the whole screen to operate the target object in the screen with the finger or the like, the above-described object and vicinity thereof may be hidden by the operator's hand. In contrast with this, when the operator tries to operate the target object so as not to hide the screen by his/her hand, unnatural movement of the hand may be forced. For example, when pressing a tab button in the screen to switch the screen, the operator may have to take his/her hand off the screen in order to see the displayed screen.

A touch pen may be used in a case where delicate operation is needed or the like. However, even in this case, a part of the screen is hidden by a pen tip or the operator's hand, which may cause deterioration of operability.

In addition, although one of characteristics of the touch panel is to be able to perform dynamic operation by the operator moving his/her finger or the touch pen on the screen, an efficiency of operation may be deteriorated since movement of the hand takes time.

The present invention has been made in view of the above, and an object thereof is to provide an electronic device that can improve operability at the time of input operation to a touch panel.

In order to achieve the above-described object, a first aspect of the present invention is an electronic device, including: a display that displays an input screen; a touch panel that is arranged on the display and detects contact operation by an operator; and a controller that displays an operation region in the input screen, and controls operation processing for the input screen based on the contact operation to the touch panel with respect to the operation region, in a touch pad input mode.

A second aspect of the electronic device pertaining to the present invention is that the controller can switch an input mode between a direct input mode to receive direct operation for the input screen and the touch pad input mode.

A third aspect of the electronic device pertaining to the present invention is that the controller makes the operation region translucent in a state where there is no contact with the operation region, and in a state where there is contact with the operation region, the controller makes transparency of the operation region lower than in the state where there is no contact with the operation region.

A fourth aspect of the electronic device pertaining to the present invention is that when a contact position moves while being in contact with the operation region, and the contact position reaches an edge of the operation region from within the operation region, the controller moves the operation region according to the movement of the contact position.

A fifth aspect of the electronic device pertaining to the present invention is that the controller adjusts a color of the operation region according to a background color.

### BRIEF DESCRIPTION OF THE DRAWINGS

FIG. 1 is a block diagram showing a configuration of a printing machine pertaining to an embodiment.

FIG. 2 is a flow chart of switching processing of an input mode.

FIG. 3 is a diagram showing one example of an input screen on which a touch pad window is displayed.

FIG. 4 is a diagram showing a state where transparency of an operation region is lowered.

FIG. 5 is an explanatory diagram of operation to move the touch pad window.

FIG. 6 is an explanatory diagram of operation to change a size of the touch pad window.

### DESCRIPTION OF THE PREFERRED EMBODIMENTS

Hereinafter, an embodiment of the present invention will be explained with reference to drawings. A same or an equal symbol is given to a same or an equal portion or component through each drawing.

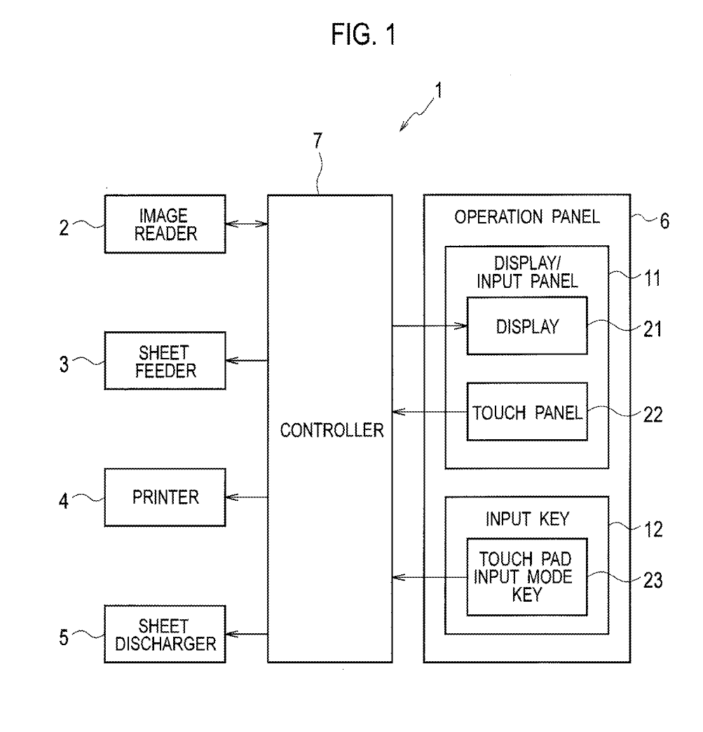

FIG. 1 is a block diagram showing a configuration of a printing machine pertaining to the embodiment of the present invention. As shown in FIG. 1, a printing machine 1 pertaining to the embodiment includes: an image reader 2; a sheet feeder 3; a printer 4; a sheet discharger 5; an operation panel 6; and a controller 7. It is to be noted that the printing machine 1 corresponds to an electronic device in claims.

The image reader 2 optically reads an image of an original, and generates image data.

The sheet feeder 3 feeds sheet stacked on a sheet feed tray to the printer 4.

The printer 4 performs printing on sheet fed by the sheet feeder 3 based on the image data generated by the image reader 2 or image data input to the printing machine 1 from an external terminal. The printer 4 has a printing unit of an ink-jet system or the like.

The sheet discharger 5 discharges sheets, on which the image data has been printed by the printer 4, to a sheet discharge tray.

The operation panel 6 receives various types of input operation by an operator. The operation panel 6 includes a display/input panel 11 and an input key 12.

The display/input panel 11 displays an input screen, and receives the input operation by the operator. The display/input panel 11 includes a display 21 and a touch panel 22.

The display 21 displays various types of input screens or the like. The display 21 includes a liquid crystal display panel and the like.

The touch panel 22 is arranged on the display 21 in an overlapping manner. The touch panel 22 detects contact operation by the operator. Specifically, the touch panel 22 detects a contact position of an operator's finger, a touch pen, or the like with the touch panel 22, and outputs coordinate data of the contact position to the controller 7.

Here, while the finger or the like is in contact with the touch panel 22, the touch panel 22 continuously detects the contact position for each predetermined timing, and can output coordinate data of the detected contact position. As a result of this, the touch panel 22 can detect operation in which the operator moves (slides) the contact position while making his/her finger or the like in contact with the touch panel 22. In addition, the touch panel 22 detects contacts simultaneously made on a plurality of points, respectively, and can output coordinate data indicating the respective contact positions. As a result of this, the touch panel 22 can detect so-called pinch operation. The pinch operation is operation in which the operator simultaneously brings his/her two fingers or the like into contact with the touch panel 22, and opens and closes the two fingers or the like while making them in contact with the touch panel 22. Operation in which the operator opens his/her two fingers or the like is pinch-out operation, and operation in which the operator closes his/her two fingers or the like is pinch-in operation.

The input key 12 includes various types of hardware keys, such as a start key, a stop key, and a numerical keypad (neither is shown). In addition, the input key 12 includes a touch pad input mode key 23 that is a dedicated hardware key for receiving a start instruction of a touch pad input mode, which will be mentioned later.

The controller 7 controls behavior of the whole printing machine 1. The controller 7 is configured to include a CPU, a RAM, a ROM, and storages, such as a hard disk.

The controller 7 can switch an input mode with respect to the display/input panel 11 between a direct input mode and the touch pad input mode. The direct input mode is the mode to receive direct operation for the input screen displayed on the display 21. The touch pad input mode is the mode to receive input operation in a touch pad window 40, which will be mentioned later, displayed in the input screen. In the touch pad input mode, the touch panel 22 detects contact operation by the operator, and the controller 7 controls operation processing for the input screen based on the operator's contact operation to the touch panel 22 with respect to an operation region 41 of the touch pad window 40.

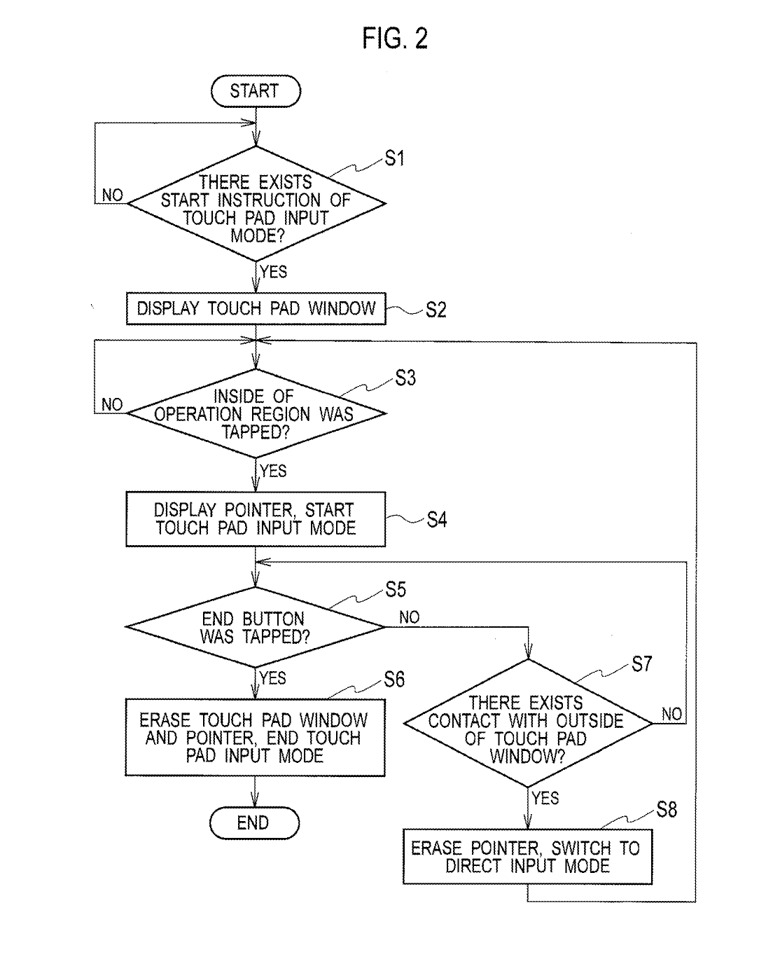

Next, switching processing of an input mode for the display/input panel 11 will be explained. FIG. 2 is a flow chart of the switching processing of the input mode. The input mode indicates the direct input mode at the time of starting processing of the flow chart of FIG. 2.

In step S1 of FIG. 2, the controller 7 determines whether or not start of the touch pad input mode has been instructed. Specifically, the controller 7 determines whether or not the touch pad input mode key 23 has been pressed. When determining that the start of the touch pad input mode has not been instructed (step S1: NO), the controller 7 repeats step S1.

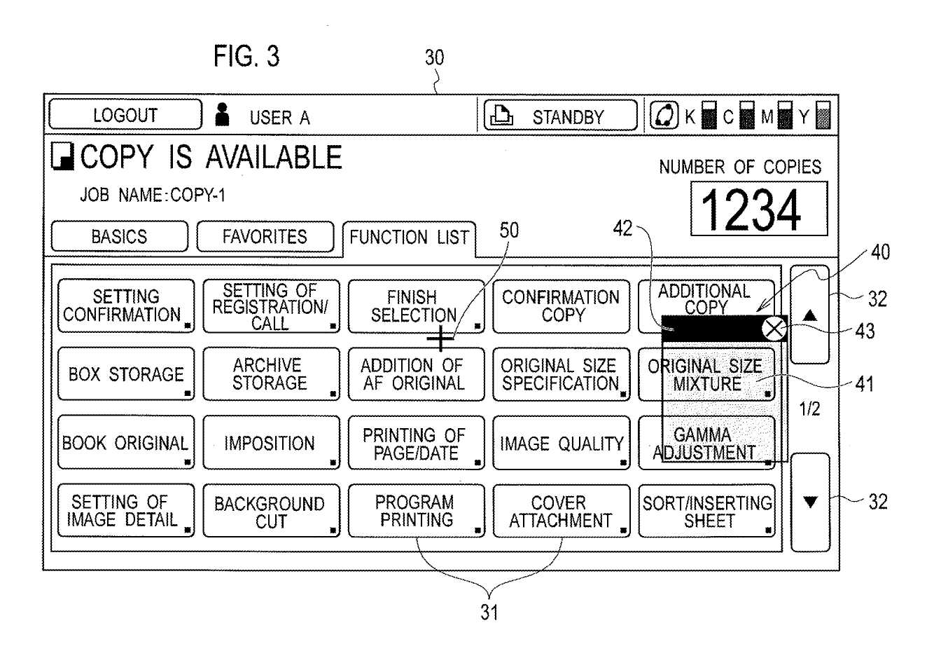

When determining that the start of the touch pad input mode has been instructed (step S1: YES), in step S2, the controller 7, as shown in FIG. 3, displays the touch pad window 40 in an input screen 30 displayed on the display 21. In this case, the controller 7 displays the touch pad window 40 at a predetermined initial position.

Here, in an example of FIG. 3, objects, such as various types of function buttons 31 and page switching buttons 32, are displayed on the input screen 30.

The touch pad window 40 has the operation region 41, a title bar 42, and an end button 43.

The operation region 41 is a region where input operation for the input screen 30 by the operator is received in the touch pad input mode. The operation region 41 is displayed translucent.

The title bar 42 is a region where operation to move the touch pad window 40 is received. When the operator performs operation (drag operation) to move his/her finger or the like while making it in contact with an inside of the title bar 42, the touch pad window 40 moves. The title bar 42 is arranged adjacently on an upper side of the operation region 41.

The end button 43 is the button for receiving an end instruction of the touch pad input mode. The end button 43 is arranged in the title bar 42.

After displaying the touch pad window 40 in step S2, in step S3, the controller 7 determines whether or not an inside of the operation region 41 has been tapped. Tap is operation to lightly flip the touch panel 22. When determining that the inside of the operation region 41 has not been tapped (step S3:NO), the controller 7 repeats step S3.

When determining that the inside of the operation region 41 has been tapped (step S3: YES), in step S4, the controller 7 displays a pointer 50 at an initial position in the input screen 30. As a result of this, the direct input mode is switched, and the touch pad input mode is started. An initial position of the pointer 50 is, for example, set to a center of the input screen 30.

The pointer 50 instructs an operation target in the touch pad input mode. When the operator slides his/her finger or the like while making it in contact with the inside of the operation region 41, the pointer 50 moves accordingly.

Moreover, for example, when the inside of the operation region 41 is double-tapped in a state where the pointer 50 is arranged on a certain function button 31, the controller 7 determines that the function button 31 has been pressed, and executes processing according to the function button 31.

It is to be noted that when a predetermined time (for example, for 1 second) elapses while the contact position has not been moved in the operation region 41, the controller 7 may execute repeat processing. For example, when a predetermined time elapses while the contact position has not been moved in the operation region 41 in a state where the pointer 50 has been arranged on the page switching button 32, the controller 7 may repeatedly execute page switching processing.

After the touch pad input mode is started, in step S5, the controller 7 determines whether or not the end button 43 has been tapped.

When determining that the end button 43 has been tapped (step S5: YES), in step S6, the controller 7 erases the touch pad window 40 and the pointer 50, and ends the touch pad input mode. As a result of this, the mode is switched to the direct input mode.

When determining that the end button 43 has not been tapped (step S5: NO), in step S7, the controller 7 determines whether or not contact with an outside of the touch pad window 40 has been detected. When determining that the contact with the outside of the touch pad window 40 has not been detected (step S7: NO), the controller 7 returns to step S5.

When determining that the contact with the outside of the touch pad window 40 has been detected (step S7: YES), in step S8, the controller 7 switches the touch pad input mode to the direct input mode. Here, the controller 7 does not erase the touch pad window 40, but erases the pointer 50. After this, the controller 7 returns to step S3.

In the direct input mode, direct operation for the input screen 30 is received. For example, when detecting contact with a certain function button 31, the controller 7 determines that the function button 31 has been pressed, and executes processing according to the function button 31.

As explained above, the touch pad input mode is provided in the printing machine 1. In the touch pad input mode, the controller 7 controls operation processing for the input screen 30 based on contact operation with respect to the operation region 41 of the touch pad window 40. Namely, operation for the whole input screen 30 is received in the operation region 41. As a result of this, it can be reduced that the operator hides a target object and vicinity thereof by his/her hand or the like during input operation. In addition, it becomes possible for the operator to efficiently perform input operation without largely moving his/her hand more than necessary. As described above, according to the printing machine 1, operability at the time of input operation can be improved.

As shown in FIG. 3, when the touch pad window 40 and the pointer 50 are arranged at positions where they do not overlap with each other, by a series of processing, can be achieved a state where the operation region 41 that is a location at which the operator double-taps his/her finger, and a position of the function button 31 which is the operation target that the controller 7 determines to be pressed by a double tap of the operator, do not overlap with each other. Namely, at the time of operation, the object as the operation target and vicinity thereof can be prevented from being hidden by the operator's hand.

The pointer 50 may be moved by a moving amount and in a moving direction as same as those of the touch pad window 40. Alternatively, the pointer 50 may be moved using a moving amount obtained by multiplying the moving amount of the touch pad window 40 by a predetermined scale factor, and the moving direction of the touch pad window 40. The operator may be able to select a method for moving the pointer 50 when sliding the touch pad window 40.

Movement of the pointer 50 at the time of the slide of the touch pad window 40 is decided as described above, and thereby it becomes possible for the operator to efficiently perform input operation without largely moving his/her hand more than necessary. According to the above-described printing machine 1, operability at the time of input operation can be improved.

In addition, in the printing machine 1, the touch pad input mode and the direct input mode can be switched. As a result of this, in the direct input mode, can be maintained a characteristic in which original dynamic operation of the touch panel can be performed.

In addition, since the operation region 41 of the touch pad window 40 is translucent, an object located on the background can be visually recognized.

In addition, the touch pad window 40 is a so-called floating window, and is movable according to drag operation to the title bar 42. As a result of this, the touch pad window 40 can be moved to an operator's desired position.

It is to be noted that when the pointer 50 is omitted, for example, a color of a current operation target of the function buttons 31 is changed to a predetermined color, and the operator slides his/her finger or the like in the operation region 41, the function button 31 that changes in color according to the slide is sequentially changed, and thereby the operation target may be set to be selectable. In this case, when the inside of the operation region 41 is double-tapped, the controller 7 determines that the function button 31 changed in colors has been pressed, and executes processing according to the function button 31.

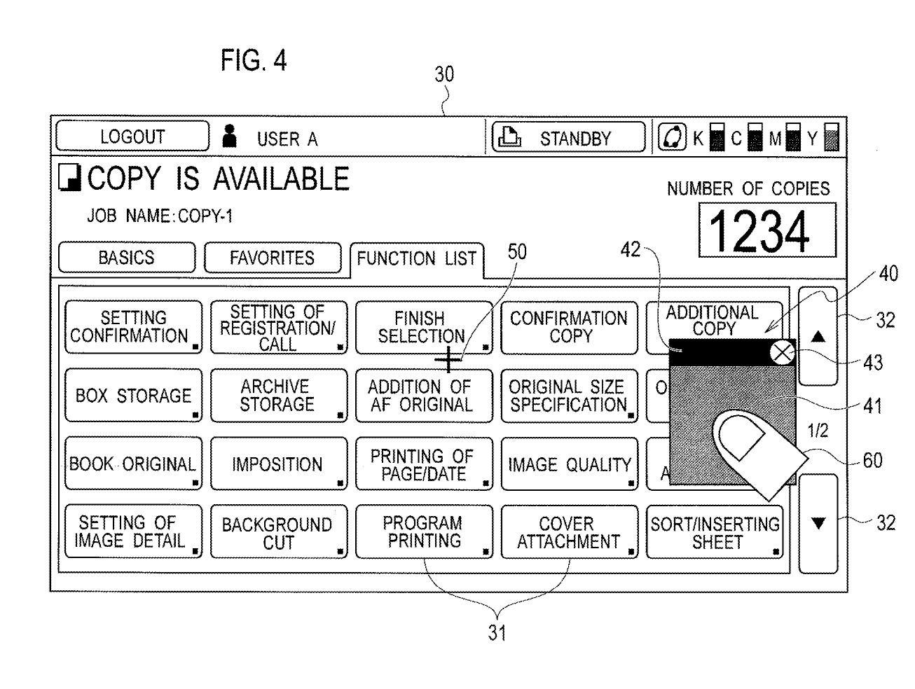

In addition, transparency of the operation region 41 in the state where there is contact with the operation region 41 may be set lower than in the state where there is no contact therewith. In this case, for example, as shown in FIG. 4, when the operator contacts the inside of the operation region 41 with a finger 60, the controller 7 lowers the transparency of the operation region 41, and makes it substantially opaque. When a predetermined time elapses after the contact with the operation region 41 is lost, the controller 7 raises the transparency of the operation region 41, and makes it translucent as in FIG. 3. A predetermined time until the transparency of the operation region 41 is raised may be able to be set by the operator. In addition, the controller 7 may also raise transparency of the title bar 42, the end button 43, and the pointer 50 together with the operation region 41.

As a result of this, when the operator is performing operation with respect to the operation region 41, the operation is made easy because the operation region 41 is clearly displayed, and when the operator does not perform operation with respect to the operation region 41, it is made easy to visually recognize display of the whole input screen 30.

In addition, although in the above-described embodiment, the touch pad window 40 is displayed at the initial position when the touch pad input mode is started, the touch pad window 40 may be displayed at a position when the last touch pad input mode ended. In addition, in starting the touch pad input mode, the operator may be able to previously select whether the touch pad window 40 is displayed at the initial position, or is displayed at the position when the last touch pad input mode ended. It is to be noted that the same is true for a display position of the pointer 50.

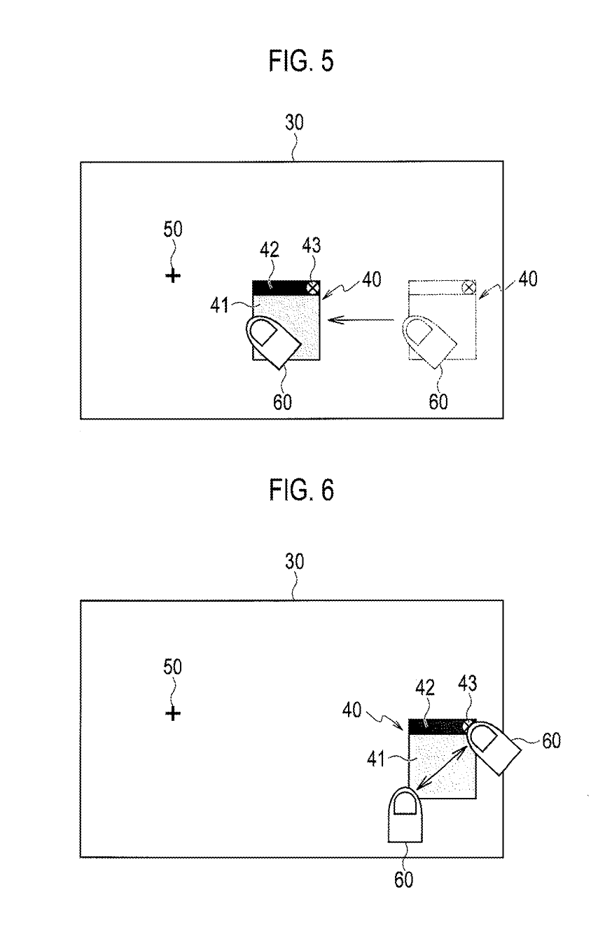

In addition, although in the above-described embodiment, the touch pad window 40 is moved according to the drag operation for the title bar 42, the touch pad window 40 may be movable even by operation to put the finger 60 on an edge of the operation region 41 and to slide the finger 60 as shown in FIG. 5. In this case, when the operator brings the finger 60 into contact with the inside of the operation region 41 to slide the finger 60, and a contact position reaches the edge of the operation region 41, the controller 7, as shown in FIG. 5, moves the touch pad window 40 according to movement of the contact position with the finger 60. As a result of this, operability for moving the touch pad window 40 improves. It is to be noted that the operator may be able to previously select whether or not the touch pad window 40 can be moved by the above operation. In addition, although a case of operation with the finger 60 is shown in FIG. 5, operation with a touch pen or the like may be employed.

In addition, a size of the touch pad window 40 may be able to be changed according to contact operation to the touch panel 22. For example, as shown in FIG. 6, the controller 7 may magnify the touch pad window 40 according to pinch-out operation with respect to the operation region 41 with the two fingers 60. And the controller 7 may minify the touch pad window 40 according to pinch-in operation with respect to the operation region 41 with the two fingers 60. As a result of this, the touch pad window 40 can be adjusted to an operator's desired size.

In addition, the operator may be able to set colors of the operation region 41 and the title bar 42. In addition, the color of the operation region 41 may be made to be automatically adjusted according to a background color. For example, the controller 7 adjusts the color of the operation region 41 to be a complementary color of the background color. As a result of this, the operation region 41 can be highlighted.

In addition, the touch pad input mode key 23 may be omitted, and a function to receive the start instruction of the touch pad input mode may be assigned to a general-purpose key located at the input key 12. In addition, a button to receive the start instruction of the touch pad input mode may be displayed in the input screen 30.

In addition, the end button 43 of the touch pad window 40 is omitted, and a dedicated hardware key for receiving the end instruction of the touch pad input mode may be provided at the input key 12. In addition, a function to receive the end instruction of the touch pad input mode may be assigned to the general-purpose key located at the input key 12.

In addition, when a predetermined time elapses in a state where there is no contact with the operation region 41, the touch pad input mode may be automatically ended, and the touch pad window 40 and the pointer 50 maybe erased. The operator may be able to set a predetermined time until the touch pad input mode is automatically ended.

In addition, although in the above-described embodiment, a shape of the touch pad window 40 is set as a rectangle, it may be other shapes, such as a circle. In addition, the operator may be able to select the shape of the touch pad window 40.

In addition, although the printing machine 1 has been explained in the above-described embodiment, the present invention can be applied to various electronic devices provided with a touch panel, other than the printing machine 1.

The present invention is not limited to the above-described embodiment as it is, and it can be embodied by modifying components without departing from the spirit of the invention in an implementation phase. In addition, various inventions can be formed by appropriate combinations of the plurality of components disclosed in the above-described embodiment. For example, some components may be eliminated from all the components shown in the embodiment.

The present application claims the priority based on Japanese Patent Application No. 2012-276458 filed on Dec. 19, 2012, the entire contents of which is incorporated herein by reference.

### INDUSTRIAL APPLICABILITY

According to the present invention, operation for an input screen is received in an operation region displayed in an input screen, whereby it can be reduced that an operator hides a target object and vicinity thereof by his/her hand or the like during input operation, and operability at the time of the input operation can be improved.

### DESCRIPTION OF REFERENCE NUMERALS

1 printing machine

2 image reader

3 sheet feeder

4 printer

5 sheet discharger

6 operation panel

7 controller

11 display/input panel

12 input key

21 display

22 touch panel

23 touch pad input mode key

30 input screen

40 touch pad window

41 operation region

42 title bar

43 end button

50 pointer

What is claimed is:

1. An electronic device comprising:
a display that displays an input screen;
a touch panel that is arranged on the display and detects contact operation by an operator; and
a controller that displays an operation region in the input screen, and controls operation processing for the input screen based on the contact operation to the touch panel with respect to the operation region, in a touch pad input mode.

2. The electronic device according to claim 1,
wherein the controller can switch an input mode between a direct input mode to receive direct operation for the input screen and the touch pad input mode.

3. The electronic device according to claim 1,
wherein the controller makes the operation region translucent in a state where there is no contact with the operation region, and in a state where there is contact with the operation region, the controller makes transparency of the operation region lower than in the state where there is no contact with the operation region.

4. The electronic device according to claim 1,
wherein when a contact position moves while being in contact with the operation region, and the contact position reaches an edge of the operation region from within the operation region, the controller moves the operation region according to the movement of the contact position.

5. The electronic device according to claim 1,
wherein the controller adjusts a color of the operation region according to a background color.

6. A control method for an electronic device, comprising:
detecting contact operation by an operator by a touch panel arranged on a display that displays an input screen;
displaying an operation region in the input screen; and
controlling operation processing for the input screen based on the contact operation with respect to the operation region.
